(19) United States
(12) Patent Application Publication
(10) Pub. No.: US 2006/0089485 A1
(43) Pub. Date: Apr. 27, 2006

(54) End-capped poly(ester amide) copolymers

(76) Inventors: Jessica Renee DesNoyer, San Jose, CA (US); Stephen Dirk Pacetti, San Jose, CA (US); Vidya Nayak, Cupertino, CA (US); Lothar Kleiner, Los Altos, CA (US)

Correspondence Address: SQUIRE, SANDERS & DEMPSEY LLP, 1 MARITIME PLAZA, SUITE 300, SAN FRANCISCO, CA, 94111, US

(21) Appl. No.: 10/975,247

(22) Filed: Oct. 27, 2004

(51) Int. Cl. C08G 63/02; C08G 69/08

(52) U.S. Cl. 528/272; 528/310

(57) ABSTRACT

Provided herein is an end-capped poly(ester amide) PEA) polymer and the method of making the polymer. The PEA polymer is substantially free of active amino end groups and/or activated carboxyl groups. The PEA polymer can form a coating on an implantable device, one example of which is a stent. The coating can optionally include a biobeneficial material and/or optionally with a bioactive agent. The implantable device can be used to treat or prevent a disorder such as one of atherosclerosis, thrombosis, restenosis, hemorrhage, vascular dissection or perforation, vascular aneurysm, vulnerable plaque, chronic total occlusion, claudication, anastomotic proliferation for vein and artificial grafts, bile duct obstruction, ureter obstruction, tumor obstruction, and combinations thereof.

### BACKGROUND OF THE INVENTION

1. Field of the Invention

This invention generally relates to end-capping poly(ester amide) copolymers useful for coating an implantable device such as a drug-delivery stent.

2. Description of the Background

Some polymeric materials which are useful as carriers of bioactive substances can be used to coat an implantable device such as a stent to reduce restenosis and other problems in association with an operation such as stenting. One of such materials is poly(ester amide) (PEA) (see, U.S. Pat. No. 6,503,538, B1).

PEA can be made by condensation polymerization utilizing, among others, diamino subunits and dicarboxylic acids (Scheme I). In Scheme I, the dicarboxylic acids are converted to an active di-p-nitrophenyl derivative.

As shown in Scheme I, when the dicarboxylic acid and the diamino subunits are used stoichiometrically, the PEA formed would have one terminal carboxylic acid group and one amino group. When the dicarboxylic acid and the diamino subunits are not used at a ratio of 1:1, the PEA thus formed can have end groups in favor of the carboxylic acid group, if more of the dicarboxylic acid subunit is used than the diamino subunit, or in favor of the amino group, if more of the diamino subunit is used than the dicarboxylic acid subunit. Accordingly, the PEA molecule would have reactive carboxylic acid or amino end groups.

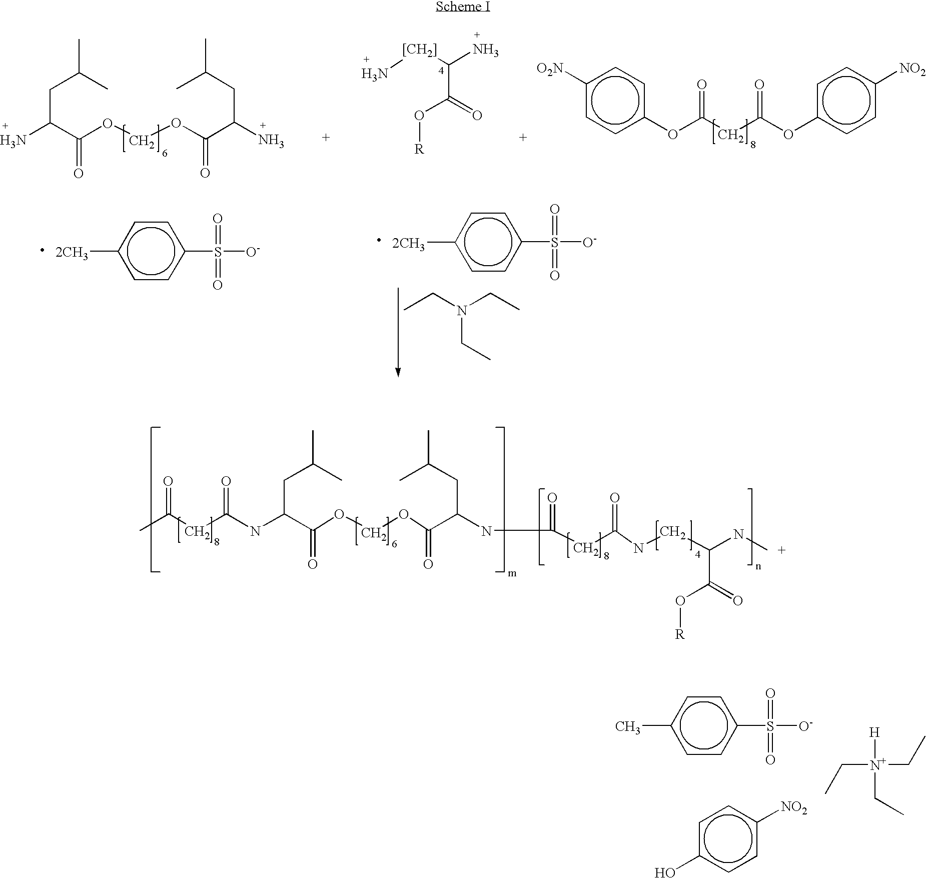

Reactive end groups in the PEA polymer can be problematic. First, since the active amino and carboxyl end groups are still present, the polymerization can continue. Second, if the PEA polymer thus formed was combined with a drug substance that possesses a primary or secondary amino group, or a thiol group, there is a high likelihood that the drug will react with a p-nitro-phenyl-carboxyl end group and covalently attach to the PEA polymer. Third, a step subsequent to the polymerization shown in Scheme I is to remove the protective group from the lysine carboxyl. This generates the free carboxyl to which other moieties may be attached. Attachment requires that this liberated carboxyl be activated, usually by a carbodiimide such as 1-(3-(Dimethylamino)propyl)-3-ethylcarbodiimide (EDC) or Dicyclohexylcarbodiimide (DCC). Once so activated, this carboxyl can readily react with an amino end-group. If free amino groups are present on the termini of PEA molecules, this will have the overall effect of crosslinking the PEA polymer at a low crosslinking density. At best, this will lead to irreproducibility between batches, and at worst the crosslinked PEA polymer will not be processable and will not be able to be coated onto a stent. Fourth, the carboxyl end-group of the PEA made according to Scheme I will be p-nitrophenyl carboxyl. In addition to being reactive, this p-nitrophenyl group is toxic. If it is still part of the PEA polymer when coated onto a stent, the p-nitrophenyl group will be released into the body, which is highly undesirable.

The embodiments of the present invention provide for methods of addressing these issues.

### SUMMARY OF THE INVENTION

Provided herein are methods of end-capping poly(ester amide) (PEA) polymers to inactivate the amino end groups and carboxyl end-groups or free carboxyl groups on the PEA polymer. The methods generally include reacting a chemical agent with the amino end groups of the PEA polymer to render them inactive and then optionally reacting a second chemical agent with the carboxyl end groups to inactivate the carboxylic acid groups. Alternatively, the carboxyl end groups can be inactivated by a first chemical agent, followed by the inactivation of the amino end groups by a second chemical agent. In some embodiments, the first chemical agent and/or the second chemical agent can be a drug molecule or drug molecules, which are defined below as bioactive agents. In some other embodiments, the carboxyl end-groups and amino end-groups are inactivated substantially simultaneously by supplying an appropriate agent or agents. Still, in some other embodiments, the carboxyl end-groups and amino end-groups can be inactivated during the sterilization process. For example, a sterilizing agent such as an epoxide (e.g., ethylene oxide) can inactivate free amino end groups and free carboxyl end groups.

The end-capped PEA polymer is completely free of active amino end groups and/or activated carboxyl end groups (e.g., p-nitrophenyl carboxyl end groups) or substantially free of active amino end groups and/or activated carboxyl end groups (e.g., p-nitrophenyl carboxyl end groups). In one embodiment, the end-capped PEA polymer has about or less than 50%, 20%, 10%, 1%, 0.5%, 0.1%, 0.01%, 0.001%, or 0.0001% residual active amino end groups and/or about or less than 50%, 20%, 10%, 1%, 0.5%, 0.1%, 0.01%, 0.001%, or 0.0001% residual activated carboxyl end groups (e.g., p-nitrophenyl carboxyl end groups). In a preferred embodiment, the end-capped PEA polymer has less than 1% residual active amino end groups and less than 1% residual activated carboxyl end groups (e.g., p-nitrophenyl carboxyl end groups) based on the total number of polymer chain end groups.

The end-capped PEA polymers can be used to coat an implantable device or to form the implantable device itself, one example of which is a stent that is used as a scaffold in the treatment of coronary artery disease. In some embodiments, the end-capped PEA can be used optionally with a biobeneficial material and/or optionally a bioactive agent to coat an implantable device. In some other embodiments, the end-capped capped PEA polymer can be used with one or more biocompatible polymers, which can be biodegradable, bioabsorbable, non-degradable, or non-bioabsorbable polymer.

The implantable medical device can be a stent that can be a metallic, biodegradable or nondegradable. The stent can be intended for neurovasculature, carotid, coronary, pulmonary, aorta, renal, biliary, iliac, femoral, popliteal, or other peripheral vasculature. The stent can be used to treat, prevent or ameliorate a disorder such as atherosclerosis, thrombosis, restenosis, hemorrhage, vascular dissection or perforation, vascular aneurysm, vulnerable plaque, chronic total occlusion, claudication, anastomotic proliferation for vein and artificial grafts, bile duct obstruction, ureter obstruction, tumor obstruction, or combinations thereof.

### DETAILED DESCRIPTION

Provided herein is a method of end-capping poly(ester amide) (PEA) polymers to inactivate the amino end groups and carboxyl end-groups or free carboxyl groups on the PEA polymer. The method generally includes reacting a chemical agent with the amino end groups of the PEA polymer so as to render them inactive and then optionally reacting a second chemical agent with the carboxyl end groups to inactivate the carboxylic acid groups. Alternatively, the carboxyl end groups can be inactivated by a first chemical agent, followed by the inactivation of the amino end groups by a second chemical agent. In some embodiments, the first chemical agent and/or the second chemical agent can be a drug molecule or drug molecules, which are defined below as bioactive agents. In some other embodiments, the carboxyl end-groups and amino end-groups are inactivated substantially simultaneously by supplying an appropriate agent or agents. Still, in some other embodiments, the carboxyl end-groups and amino end-groups can be inactivated during the sterilization process. For example, a sterilizing agent such as an epoxide (e.g., ethylene oxide) can inactivate free amino end groups and free carboxyl end groups.

As used herein, the term PEA encompasses a polymer having at least one ester grouping and at least one amide grouping in the backbone. One example is the PEA polymer made according to Scheme I, above. Other PEA polymers are described in, e.g., U.S. Pat. No. 6,503,538 B1.

The activated carboxyl groups can be any carboxyl group containing any of, e.g., mononitrophenyl such as p-nitrophenyl, m-nitrophenyl or o-nitrophenyl, dinitrophenyl groups, trinitrophenyl groups, and a phenyl bearing one, two, or three cyano, halogen, keto, ester, or sulfone groups.

The end-capped PEA polymer is completely free of active amino end groups and/or activated carboxyl end groups (e.g., p-nitrophenyl carboxyl end groups) or substantially free of active amino end groups and/or activated carboxyl end groups (e.g., p-nitrophenyl carboxyl end groups). In one embodiment, the end-capped PEA polymer has about or less than 50%, 20%, 10%, 1%, 0.5%, 0.1%, 0.01%, 0.001% or 0.0001% residual active amino end groups and/or about or less than 50%, 20%, 10%, 1%, 0.5%, 0.1%, 0.01%, 0.001% or 0.0001% residual activated carboxyl end groups (e.g., p-nitrophenyl carboxyl end groups). In a preferred embodiment, the end-capped PEA polymer has less than 1% residual active amino end groups and less than 1% residual activated carboxyl end groups (e.g., p-nitrophenyl carboxyl end groups) based on the total number of polymer chain end groups.

The end-capped PEA polymers, optionally with a non-PEA biocompatible polymer and/or optionally a biobeneficial material and/or optionally a bioactive agent, can be used to coat an implantable device or to form the implantable device itself, one example of which is a stent. In some embodiments, the end-capped PEA can be used optionally with a biobeneficial material and/or optionally a bioactive agent to coat an implantable device. In some other embodiments, the end-capped PEA polymer can be used with one or more biocompatible polymers, which can be biodegradable, bioabsorbable, non-degradable, or non-bioabsorbable polymer.

The implantable medical device can be a stent that can be a metallic, biodegradable or nondegradable . The stent can be intended for neurovasculature, carotid, coronary, pulmonary, aorta, renal, biliary, iliac, femoral, popliteal, or other peripheral vasculature. The stent can be used to treat, prevent or ameliorate a disorder such as atherosclerosis, thrombosis, restenosis, hemorrhage, vascular dissection or perforation, vascular aneurysm, vulnerable plaque, chronic total occlusion, claudication, anastomotic proliferation for vein and artificial grafts, bile duct obstruction, ureter obstruction, tumor obstruction, or combinations thereof.

### End-Capping Amino Groups

In one embodiment, the amino active groups on the PEA polymer can be end-capped first. The end-capping process is a separate reaction done after the polymerization. The PEA polymer may, or may not be purified before the amino endcapping reaction. Specific embodiments of the methods are shown below.

In one embodiment, the active amino group can be end-capped by alkylation of the amino group, forming a quaternary amine (Scheme II):

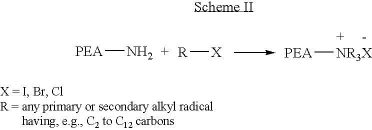

In another embodiment, the active amino group can be end-capped via the formation of an amide group by reaction with an acid chloride, or other halogenated acid (Scheme III):

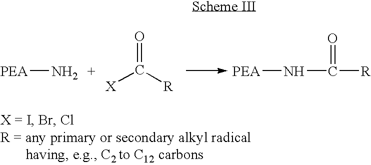

The active amino group can be subjected to reductive amination with an aldehyde in the presence of a reducing agent, e.g., NaCNBH₃ and NaBH₄ (Scheme IV):

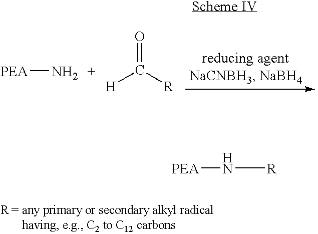

In still a further embodiment, the active amino group can be rendered inactive by reaction with a diazo compound in the presence of a Lewis acid such as BF₃, forming an alkylated amino group (Scheme V):

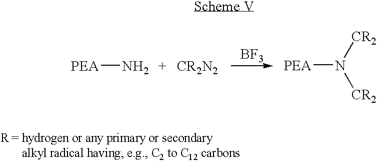

In some other embodiments, diazotization of the amine can be used to inactivate an active primary amino group. One example of such diazotization is shown in Scheme VI.

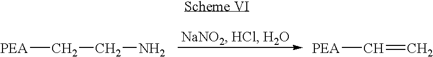

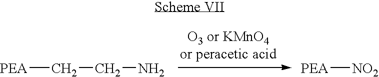

Alternatively, an active amino group on the PEA polymer can react with an anhydride, an epoxide, isocyanate, or isothiocyanate respectively to inactivate the active amino group (Scheme VIII): 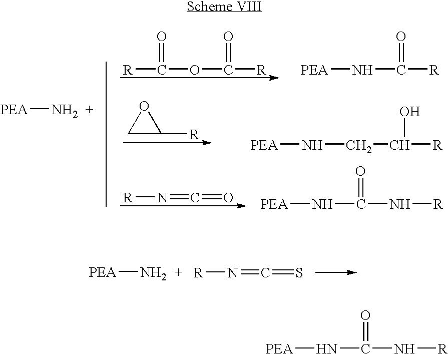
In Scheme VIII, R is a carbon alkyl, which can be saturated or unsaturated and linear or branched alkyl, cycloalkyl, phenyl, or aryl group. Preferably, R is a carbon alkyl or cycloalkyl with 2-12 carbons.

An active amino group on the PEA polymer may also be inactivated via Michael Addition with an α,β-unsaturated ester, ketone, aldehyde or another unsaturated electron-withdrawing group, e.g., —CN. One such Michael addition reaction is shown in Scheme IX:

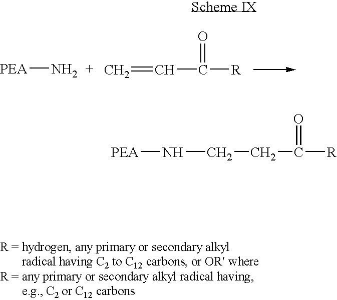

### End-Capping Carboxyl Groups

In another embodiment, carboxyl groups or activated carboxyl groups on the PEA polymer can be inactivated by reaction with a primary amine, a secondary amine, heterocyclic amine, a thiol, alcohol, malonate anion, carbanion, or other nucleophilic group. For example, PEA with a p-nitrophenyl carboxyl end group can be inactivated per Scheme X:

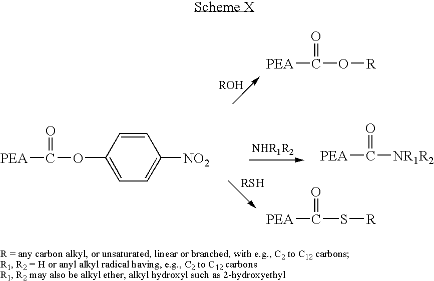

In some other embodiments, the p-nitrophenyl carboxyl group on the PEA polymer can be hydrolyzed under acidic or basic conditions so as to form a free carboxylic acid group or carboxylate group (Scheme XI):

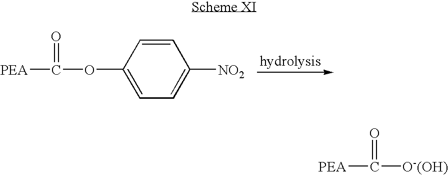

In some further embodiments, this p-nitrophenol ester may also be reacted with reducing agents such as sodium borohydride or sodium cyanoborohydride to convert the ester to a hydroxyl group.

### Biocompatible Polymer

The biocompatible polymer that can be used with the end-capped PEA in the coatings or medical devices described herein can be any biocompatible polymer known in the art, which can be biodegradable or nondegradable. Representative examples of polymers that can be used to coat an implantable device in accordance with the present invention include, but are not limited to, poly(ester amide), ethylene vinyl alcohol copolymer (commonly known by the generic name EVOH or by the trade name EVAL), poly(hydroxyvalerate), poly(L-lactic acid), poly(L-lactide), poly(D,L-lactide), poly(L-lactide-co-D,L-lactide), polycaprolactone, poly(lactide-co-glycolide), poly(hydroxybutyrate), poly(hydroxybutyrate-co-valerate), polydioxanone, polyorthoester, polyanhydride, poly(glycolic acid), poly(D,L-lactic acid), poly(D,L-lactide-co-glycolide) (PDLLAGA), poly(glycolic acid-co-trimethylene carbonate), polyphosphoester, polyphosphoester urethane, poly(amino acids), polycyanoacrylates, poly(trimethylene carbonate), poly(iminocarbonate), poly(butylene terephthalate-co-PEG-terephthalate), polyurethanes, polyphosphazenes, silicones, polyesters, polyolefins, polyisobutylene and ethylene-alphaolefin copolymers, acrylic polymers and copolymers, vinyl halide polymers and copolymers, such as polyvinyl chloride, polyvinyl ethers, such as polyvinyl methyl ether, polyvinylidene halides, such as vinylidene fluoride based home or copolymer under the trade name Solef™ or Kynar™, for example, polyvinylidene fluoride (PVDF) or poly(vinylidene-co-hexafluoropropylene) (PVDF-co-HFP) and polyvinylidene chloride, polyacrylonitrile, polyvinyl ketones, polyvinyl aromatics, such as polystyrene, polyvinyl esters, such as polyvinyl acetate, copolymers of vinyl monomers with each other and olefins, such as ethylene-methyl methacrylate copolymers, acrylonitrile-styrene copolymers, ABS resins, and ethylene-vinyl acetate copolymers, polyamides, such as Nylon 66 and polycaprolactam, alkyd resins, polycarbonates, polyoxymethylenes, polyimides, polyethers, poly(glyceryl sebacate), poly(propylene fumarate), epoxy resins, polyurethanes, rayon, rayon-triacetate, cellulose acetate, cellulose butyrate, cellulose acetate butyrate, cellophane, cellulose nitrate, cellulose propionate, cellulose ethers, and carboxymethyl cellulose.

The biocompatible polymer can provide a controlled release of a bioactive agent, if included in the coating and/or if binding the bioactive agent to a substrate, which can be the surface of an implantable device or a coating thereon. Controlled release and delivery of bioactive agent using a polymeric carrier has been extensively researched in the past several decades (see, for example, Mathiowitz, Ed., Encyclopedia of Controlled Drug Delivery, C.H.I.P.S., 1999). For example, PLA based drug delivery systems have provided controlled release of many therapeutic drugs with various degrees of success (see, for example, U.S. Pat. No. 5,581,387 to Labrie, et al.). The release rate of the bioactive agent can be controlled by, for example, selection of a particular type of biocompatible polymer, which can provide a desired release profile of the bioactive agent. The release profile of the bioactive agent can be further controlled by selecting the molecular weight of the biocompatible polymer and/or the ratio of the biocompatible polymer to the bioactive agent. Additional ways to control the release of the bioactive agent are specifically designing the polymer coating construct, conjugating the active agent onto the polymeric backbone, designing a micro-phase-separated PEA where the agent resides in the more mobile segment, and designing a PEA in which the bioactive has an appropriate level of solubility. One of ordinary skill in the art can readily select a carrier system using a biocompatible polymer to provide a controlled release of the bioactive agent. Examples of the controlled release carrier system can come from the examples provided above; however, other possibilities not provided are also achievable.

A preferred biocompatible polymer is a polyester, such as one of PLA, PLGA, PGA, PHA, poly(3-hydroxybutyrate) (PHB), poly(3-hydroxybutyrate-co-3-hydroxyvalerate), poly((3-hydroxyvalerate), poly(3-hydroxyhexanoate), poly(4-hydroxybutyrate), poly(4-hydroxyvalerate), poly(4-hydroxyhexanoate), and a combination thereof, and polycaprolactone (PCL).

### Bioactive Agents

The end-capped PEA polymer described herein can form a coating or a medical device such as a stent with one or more bioactive agents. These bioactive agents can be any agent which is a therapeutic, prophylactic, or diagnostic agent. These agents can have anti-proliferative or anti-inflammatory properties or can have other properties such as antineoplastic, antiplatelet, anti-coagulant, anti-fibrin, antithrombonic, antimitotic, antibiotic, antiallergic, antioxidant as well as cystostatic agents. Examples of suitable therapeutic and prophylactic agents include synthetic inorganic and organic compounds, proteins and peptides, polysaccharides and other sugars, lipids, and DNA and RNA nucleic acid sequences having therapeutic, prophylactic or diagnostic activities. Nucleic acid sequences include genes, antisense molecules which bind to complementary DNA to inhibit transcription, and ribozymes. Some other examples of other bioactive agents include antibodies, receptor ligands, enzymes, adhesion peptides, blood clotting factors, inhibitors or clot dissolving agents such as streptokinase and tissue plasminogen activator, antigens for immunization, hormones and growth factors, oligonucleotides such as antisense oligonucleotides and ribozymes and retroviral vectors for use in gene therapy. Examples of anti-proliferative agents include rapamycin and its functional or structural derivatives, 40-O-(2-hydroxy)ethyl-rapamycin (everolimus), and its functional or structural derivatives, paclitaxel and its functional and structural derivatives. Examples of rapamycin derivatives include methyl rapamycin (ABT-578), 40-O-(3-hydroxy)propyl-rapamycin, 40-O-[2-(2-hydroxy)ethoxy]ethyl-rapamycin, and 40-O-tetrazole-rapamycin. Examples of paclitaxel derivatives include docetaxel. Examples of antineoplastics and/or antimitotics include methotrexate, azathioprine, vincristine, vinblastine, fluorouracil, doxorubicin hydrochloride (e.g. Adriamycin® from Pharmacia & Upjohn, Peapack N.J.), and mitomycin (e.g. Mutamycin® from Bristol-Myers Squibb Co., Stamford, Conn.). Examples of such antiplatelets, anticoagulants, antifibrin, and antithrombins include sodium heparin, low molecular weight heparins, heparinoids, hirudin, argatroban, forskolin, vapiprost, prostacyclin and prostacyclin analogues, dextran, D-phe-pro-arg-chloromethylketone (synthetic antithrombin), dipyridamole, glycoprotein IIb/IIa platelet membrane receptor antagonist antibody, recombinant hirudin, thrombin inhibitors such as Angiomax ä (Biogen, Inc., Cambridge, Mass.), calcium channel blockers (such as nifedipine), colchicine, fibroblast growth factor (FGF) antagonists, fish oil (omega 3-fatty acid), histamine antagonists, lovastatin (an inhibitor of HMG-CoA reductase, a cholesterol lowering drug, brand name Mevacor® from Merck & Co., Inc., Whitehouse Station, N.J.), monoclonal antibodies (such as those specific for Platelet-Derived Growth Factor (PDGF) receptors), nitroprusside, phosphodiesterase inhibitors, prostaglandin inhibitors, suramin, serotonin blockers, steroids, thioprotease inhibitors, triazolopyrimidine (a PDGF antagonist), nitric oxide or nitric oxide donors, super oxide dismutases, super oxide dismutase mimetic, 4-amino-2,2,6,6-tetramethylpiperidine-1-oxyl (4-amino-TEMPO), estradiol, anticancer agents, dietary supplements such as various vitamins, and a combination thereof. Examples of anti-inflammatory agents including steroidal and non-steroidal anti-inflammatory agents include tacrolimus, dexamethasone, clobetasol, combinations thereof. Examples of such cytostatic substance include angiopeptin, angiotensin converting enzyme inhibitors such as captopril (e.g. Capoten® and Capozide® from Bristol-Myers Squibb Co., Stamford, Conn.), cilazapril or lisinopril (e.g. Prinivil® and Prinzide® from Merck & Co., Inc., Whitehouse Station, N.J.). An example of an antiallergic agent is permirolast potassium. Other therapeutic substances or agents which may be appropriate include alpha-interferon, bioactive RGD, and genetically engineered epithelial cells. The foregoing substances can also be used in the form of prodrugs or co-drugs thereof. The foregoing substances are listed by way of example and are not meant to be limiting. Other active agents which are currently available or that may be developed in the future are equally applicable.

The dosage or concentration of the bioactive agent required to produce a favorable therapeutic effect should be less than the level at which the bioactive agent produces toxic effects and greater than the level at which non-therapeutic results are obtained. The dosage or concentration of the bioactive agent required to inhibit the desired cellular activity of the vascular region can depend upon factors such as the particular circumstances of the patient; the nature of the tissues being delivered to; the nature of the therapy desired; the time over which the ingredient administered resides at the vascular site; and if other active agents are employed, the nature and type of the substance or combination of substances. Therapeutic effective dosages can be determined empirically, for example by infusing vessels from suitable animal model systems and using immunohistochemical, fluorescent or electron microscopy methods to detect the agent and its effects, or by conducting suitable in vitro studies. Standard pharmacological test procedures to determine dosages are understood by one of ordinary skill in the art.

### Biobeneficial Material

The biobeneficial material that can be used with the end-capped PEA polymer to form the coatings or medical devices described herein can be a polymeric material or non-polymeric material. The biobeneficial material is preferably flexible and biocompatible and/or biodegradable (a term which includes biodegradable and bioabsorbable), more preferably non-toxic, non-antigenic and non-immunogenic. A biobeneficial material is one which enhances the biocompatibility of a device by being non-fouling, hemocompatible, actively non-thrombogenic, or anti-inflammatory, all without depending on the release of a pharmaceutically active agent.

Generally, the biobeneficial material has a relatively low glass transition temperature (T_{g}), e.g., a T_{g} below or significantly below that of the biocompatible polymer, described below. In some embodiments, the T_{g} is below human body temperature. This attribute would, for example, render the biobeneficial material relatively soft as compared to the biocompatible polymer and allows a layer of coating containing the biobeneficial material to fill any surface damages that may arise when an implantable device coated with a layer comprising the biocompatible polymer. For example, during radial expansion of the stent, a more rigid biocompatible polymer can crack or have surface fractures. A softer biobeneficial material can fill in the crack and fractures.

Another attribute of a biobeneficial material is hydrophlicity. Hydrophicility of the coating material would affect the drug release rate of a drug-delivery coating and, in the case that the coating material is biodegradable, would affect the degradation rate of the coating material. Generally, the higher hydrophilicity of the coating material, the higher the drug release rate of the drug-delivery coating and the higher the degradation rate of the coating if it is biodegradable.

Representative biobeneficial materials include, but are not limited to, polyethers such as poly(ethylene glycol), copoly(ether-esters) (e.g. PEO/PLA); polyalkylene oxides such as poly(ethylene oxide), poly(propylene oxide), poly(ether ester), polyalkylene oxalates, polyphosphazenes, phosphoryl choline, choline, poly(aspirin), polymers and co-polymers of hydroxyl bearing monomers such as hydroxyethyl methacrylate (HEMA), hydroxypropyl methacrylate (HPMA), hydroxypropylmethacrylamide, poly (ethylene glycol) acrylate (PEGA), PEG methacrylate, 2-methacryloyloxyethylphosphorylcholine (MPC) and n-vinyl pyrrolidone (VP), carboxylic acid bearing monomers such as methacrylic acid (MA), acrylic acid (AA), alkoxymethacrylate, alkoxyacrylate, and 3-trimethylsilylpropyl methacrylate (TMSPMA), poly(styrene-isoprene-styrene)-PEG (SIS-PEG), polystyrene-PEG, polyisobutylene-PEG, polycaprolactone-PEG (PCL-PEG), PLA-PEG, poly(methyl methacrylate)-PEG (PMMA-PEG), polydimethylsiloxane-co-PEG (PDMS-PEG), poly(vinylidene fluoride)-PEG (PVDF-PEG), PLURONIC™ surfactants (polypropylene oxide-co-polyethylene glycol), poly(tetramethylene glycol), hydroxy functional poly(vinyl pyrrolidone), biomolecules such as fibrin, fibrinogen, cellulose, starch, collagen, dextran, dextrin, hyaluronic acid, fragments and derivatives of hyaluronic acid, heparin, fragments and derivatives of heparin, glycosamino glycan (GAG), GAG derivatives, polysaccharide, elastin, chitosan, alginate, silicones, and combinations thereof. In some embodiments, the polymer can exclude any one of the aforementioned polymers.

In a preferred embodiment, the biobeneficial material is a block copolymer having flexible poly(ethylene glycol) and poly(butylene terephthalate) blocks (PEGT/PBT) (e.g., PolyActive™). PolyActive™ is intended to include AB, ABA, BAB copolymers having such segments of PEG and PBT (e.g., poly(ethylene glycol)-block-poly(butyleneterephthalate)-block poly(ethylene glycol) (PEG-PBT-PEG).

### Examples of Implantable Device

As used herein, an implantable device may be any suitable medical substrate that can be implanted in a human or veterinary patient. Examples of such implantable devices include self-expandable stents, balloon-expandable stents, stent-grafts, grafts (e.g., aortic grafts), artificial heart valves, cerebrospinal fluid shunts, pacemaker electrodes, and endocardial leads (e.g., FINELINE and ENDOTAK, available from Guidant Corporation, Santa Clara, Calif.). The underlying structure of the device can be of virtually any design. The device can be made of a metallic material or an alloy such as, but not limited to, cobalt chromium alloy (ELGILOY), stainless steel (316L), high nitrogen stainless steel, e.g., BIODUR 108, cobalt chrome alloy L-605, “MP35N,” “MP20N,” ELASTINITE (Nitinol), tantalum, nickel-titanium alloy, platinum-iridium alloy, gold, magnesium, or combinations thereof. “MP35N” and “MP20N” are trade names for alloys of cobalt, nickel, chromium and molybdenum available from Standard Press Steel Co., Jenkintown, Pa. “MP35N” consists of 35% cobalt, 35% nickel, 20% chromium, and 10% molybdenum. “MP20N” consists of 50% cobalt, 20% nickel, 20% chromium, and 10% molybdenum. Devices made from bioabsorbable or biostable polymers could also be used with the embodiments of the present invention.

### Method of Use

In accordance with embodiments of the invention, a coating of the various described embodiments can be formed on an implantable device or prosthesis, e.g., a stent. For coatings including one or more active agents, the agent will retain on the medical device such as a stent during delivery and expansion of the device, and released at a desired rate and for a predetermined duration of time at the site of implantation. Preferably, the medical device is a stent. A stent having the above-described coating is useful for a variety of medical procedures, including, by way of example, treatment of obstructions caused by tumors in bile ducts, esophagus, trachea/bronchi and other biological passageways. A stent having the above-described coating is particularly useful for treating occluded regions of blood vessels caused by atherosclerosis, abnormal or inappropriate migration and proliferation of smooth muscle cells, thrombosis, and restenosis. Stents may be placed in a wide array of blood vessels, both arteries and veins. Representative examples of sites include the iliac, renal, and coronary arteries.

For implantation of a stent, an angiogram is first performed to determine the appropriate positioning for stent therapy. An angiogram is typically accomplished by injecting a radiopaque contrasting agent through a catheter inserted into an artery or vein as an x-ray is taken. A guidewire is then advanced through the lesion or proposed site of treatment. Over the guidewire is passed a delivery catheter which allows a stent in its collapsed configuration to be inserted into the passageway. The delivery catheter is inserted either percutaneously or by surgery into the femoral artery, brachial artery, femoral vein, or brachial vein, and advanced into the appropriate blood vessel by steering the catheter through the vascular system under fluoroscopic guidance. A stent having the above-described coating may then be expanded at the desired area of treatment. A post-insertion angiogram may also be utilized to confirm appropriate positioning.

### EXAMPLES

The embodiments of the present invention will be illustrated by the following set forth prophetic examples. All parameters and data are not to be construed to unduly limit the scope of the embodiments of the invention.

### Example 1

### Preparation of co-poly-{[N,N′-sebacoyl-bis-(L-leucine)-1,6-hexylene diester]-[N,N′-sebacoyl-L-lysine benzyl ester]}

Dry triethylamine (61.6 ml, 0.44 mole) is added to a mixture of di-p-toluenesulfonic acid salt of bis-(L-leucine)-1,6-hexylene diester (120.4 g, 0.18 mole), di-p-toluenesulfonic acid salt of L-lysine benzyl ester (11.61 g, 0.02 mole), and di-p-nitrophenyl sebacinate (88.88 g, 0.2 mole) in dry DMF (110 ml). The mixture is stirred and heated at 80° C. for 12 hours.

### Example 2

The active amino endgroups on the PEA prepared in Example 1 can be endcapped according to Scheme III as follows. While stirring, the DMF/PEA solution of Example 1 is cooled to 0° C. Triethyl amine (0.0057 mole) is added and acetyl chloride (0.448 g, 0.0057 mole) is added dropwise to the mixture. Stirring is continued for 12 hours while the solution is allowed to equilibrate to room temperature. The solution is diluted with ethanol (300 ml), and poured into one liter of deionized water. The precipitated polymer is collected, extracted with two, one liter portions of phosphate buffer (0.1M, pH 7), a final, one liter portion of deionized water, isolated by suction filtration, and vacuum dried at 40° C.

### Example 3

The active amino endgroups on the PEA prepared in Example 1 can be endcapped according to Scheme IX as follows. Ethyl acrylate (0.571 g, 0.0057 mole) is added to the DMF/PEA solution of Example 1. With stirring, the solution is heated to 100° C. Prior to the mixture reaching the reaction temperature, phosphoric acid (0.011 g, 0.000114 mole) is added as an acid catalyst and the solution is stirred for 60 minutes at 100° C. The solution is diluted with ethanol (300 ml), and poured into one liter of deionized water. The precipitated polymer is collected, extracted with two, one liter portions of phosphate buffer (0.1M, pH 7), a final, one liter portion of deionized water, isolated by suction filtration, and vacuum dried at 40° C.

### Example 4

A medical article with two layers can be fabricated to comprise everolimus by preparing a first composition and a second composition, wherein the first composition is a layer containing a bioactive agent which includes a matrix of the PEA of Example 2 and a bioactive agent, and the second composition is a topcoat layer comprising the PEA of Example 2. The first composition can be prepared by mixing about 2% (w/w) of the PEA of Example 2 and about 0.33% (w/w) everolimus in absolute ethanol, sprayed onto a surface of a bare, 12 mm VISION™ stent (Guidant Corp.) and dried to form a coating. An example coating technique includes spray coating with a 0.014 fan nozzle, a feed pressure of about 0.2 atm, and an atomization pressure of about 1.3 atm; applying about 20 μg of wet coating per pass; drying the coating at about 62° C. for about 10 seconds between passes and baking the coating at about 50° C. for about 1 hour after the final pass to form a dry agent layer. The layer containing a bioactive agent would be comprised of about 336 μg of the PEA of Example 2 and about 56 μg of everolimus. The second composition can be prepared by mixing about 2% (w/w) of the PEA of Example 2 in absolute ethanol and applied using the example coating technique. The topcoat would contain about 400 μg of the PEA of Example 2. The total weight of the stent coating would be about 792 μg.

While particular embodiments of the present invention have been shown and described, it will be obvious to those skilled in the art that changes and modifications can be made without departing from this invention in its broader aspects. Therefore, the appended claims are to encompass within their scope all such changes and modifications as fall within the true spirit and scope of this invention.

What is claimed is:

1. An end-capped poly(ester amide) (PEA) polymer completely free of active amino end groups and/or activated carboxyl end groups or substantially free of active amino end groups and/or activated carboxyl end groups.

2. The end-capped PEA polymer of claim 1, having less than 50% residual active amino end groups or less than 50% residual activated carboxyl end groups.

3. The end-capped PEA polymer of claim 1, having less than 10% residual active amino end groups or less than 10% residual activated carboxyl end groups.

4. The end-capped PEA polymer of claim 1, having less than 1% residual active amino end groups or less than 1% residual activated carboxyl end groups.

5. The end-capped PEA polymer of claim 1, having less than 10% residual active amino end groups and less than 10% residual activated carboxyl end groups.

6. The end-capped PEA polymer of claim 3, wherein the activated carboxyl end group comprises nitro, cyano, halogen, keto, ester, or sulfone groups.

7. The end-capped PEA polymer of claim 3, wherein the activated carboxyl end group is p-nitrophenyl carboxyl.

8. The end-capped PEA polymer of claim 1 which is end-capped by a bioactive agent.

9. A method of modifying a poly(ester amide) (PEA) polymer, comprising:
end-capping active amino end groups by reaction with a first chemical agent, and/or
end-capping activated carboxyl end groups with a second chemical agent.

10. The method of claim 9, wherein the first chemical agent or the second chemical agent is a bioactive agent.

11. A coating for an implantable medical device comprising the PEA polymer of claim 1.

12. The coating of claim 11, further comprising a biocompatible polymer.

13. The coating of claim 11, further comprising a biobeneficial material.

14. The coating of claim 11, further comprising a bioactive agent.

15. The coating of claim 14, wherein the bioactive agent is selected from the group consisting of paclitaxel, docetaxel, estradiol, nitric oxide donors, super oxide dismutases, super oxide dismutase mimics, 4-amino-2,2,6,6-tetramethylpiperidine-1-oxyl (4-amino-TEMPO), tacrolimus, dexamethasone, rapamycin, rapamycin derivatives, 40-O-(2-hydroxy)ethyl-rapamycin (everolimus), 40-O-(3-hydroxy)propyl-rapamycin, 40-O-[2-(2-hydroxy)ethoxy]ethyl-rapamycin, and 40-O-tetrazole-rapamycin, ABT-578, clobetasol, progenitor cell capturing antibody, prohealing drugs, prodrugs thereof, co-drugs thereof, and a combination thereof.

16. The coating of claim 11, wherein the medical device is a stent.

17. The coating of claim 15, wherein the medical device is a stent.

18. An implantable medical device formed of a material comprising the end-capped PEA of claim 1.

19. The medical device of claim 18, wherein the material further comprises a bioactive agent.

20. The medical device of claim 19, wherein the bioactive agent is selected from the group consisting of paclitaxel, docetaxel, estradiol, nitric oxide donors, super oxide dismutases, super oxide dismutase mimics, 4-amino-2,2,6,6-tetramethylpiperidine-1-oxyl (4-amino-TEMPO), tacrolimus, dexamethasone, rapamycin, rapamycin derivatives, 40-O-(2-hydroxy)ethyl-rapamycin (everolimus), 40-O-(3-hydroxy)propyl-rapamycin, 40-O-[2-(2-hydroxy)ethoxy]ethyl-rapamycin, and 40-O-tetrazole-rapamycin, ABT-578, clobetasol, progenitor cell capturing antibody, prohealing drugs, prodrugs thereof, co-drugs thereof, and a combination thereof.

21. A method of treating, preventing or ameliorating a disorder in a patient comprising implanting in the patient an implantable medical device comprising the coating of claim 11, wherein the disorder is selected from the group consisting of atherosclerosis, thrombosis, restenosis, hemorrhage, vascular dissection or perforation, vascular aneurysm, vulnerable plaque, chronic total occlusion, claudication, anastomotic proliferation for vein and artificial grafts, bile duct obstruction, ureter obstruction, tumor obstruction, and combinations thereof.

22. A method of treating, preventing or ameliorating a disorder in a patient comprising implanting in the patient an implantable device comprising the coating of claim 15, wherein the disorder is selected from the group consisting of atherosclerosis, thrombosis, restenosis, hemorrhage, vascular dissection or perforation, vascular aneurysm, vulnerable plaque, chronic total occlusion, claudication, anastomotic proliferation for vein and artificial grafts, bile duct obstruction, ureter obstruction, tumor obstruction, and combinations thereof.
